(19) United States
(12) Patent Application Publication
(10) Pub. No.: US 2008/0257464 A1
(43) Pub. Date: Oct. 23, 2008

(54) Pneumatic Tyre

(76) Inventor: Jan Petrus Human, Somerset West (ZA)

Correspondence Address: DALINA LAW GROUP, P.C., 7910 IVANHOE AVE. #325, LA JOLLA, CA, 92037, US

(21) Appl. No.: 11/568,975

(22) PCT Filed: May 11, 2005
(86) PCT No.: PCT/ZA2005/000067

§ 371 Date: Dec. 15, 2006

(30) Foreign Application Priority Data
May 13, 2004 (ZA) 2004/3648
Jan. 19, 2005 (ZA) 2005/0502

(51) Int. Cl. B60C 11/02

(52) U.S. Cl. 152/209.6

(57) ABSTRACT

The invention relates to a pneumatic tyre which comprises first (10) and second (12) separable tyre parts, the first tyre part including the tyre's side walls and the inner layer of the tyre's crown and having reinforcing plies in it, and the second tyre part encircling the first tyre part and having the tread pattern (14) therein. The said second tyre part (12) further has beads (22) along both peripheries thereof, said beads being outwardly of said side walls of said first tyre part (10).

### FIELD OF THE INVENTION

THIS INVENTION relates to pneumatic tyres.

### BACKGROUND TO THE INVENTION

Tyres are conventionally constructed with the rubber crown of the tyre, in which the tread pattern is formed, inseparable from the remainder of the tyre. Hence, once the tread has worn down it is conventional to discard the entire casing. There are, however, two exceptions to this. In some instances a new tread pattern is cut into the tyre's crown. This procedure has to be carried out within the applicable legal requirements and obviously the tyre must have a sufficient rubber thickness to allow this to be done in safety. The second exception is retreading. If the casing itself, including the side walls, beads and crown are undamaged, the casing can be retreaded. This involves applying a ring of unvulcanized rubber, to the casing and then vulcanising the ring onto the casing in a mould. The tread pattern is on the inside of the mould and is impressed into the “raw” unvulcanised rubber as the mould is closed. The new tread can, in a further method, be in the form of a strip which is applied to the casing with the ends of the strip abutting. The strip is then vulcanised on and the tread pattern impressed into the rubber of the strip.

The present invention seeks to provide a tyre construction which enables a tyre casing to be used more than once without retreading, or cutting a new

### BRIEF DESCRIPTION OF THE DRAWINGS

For a better understanding of the present invention, and to show how the same may be carried into effect, reference will now be made, by way of example, to the accompanying drawings in which:

FIG. 1 is a section illustrating a conventional tyre;

FIG. 2 is a section illustrating a tyre in accordance with a first embodiment of the present invention;

FIG. 3 is a section through part of a further tyre in accordance with the present invention;

FIG. 4 is a section through a further tyre in accordance with the present invention;

FIG. 5 is a pictorial view of part of the tyre of FIG. 4;

FIGS. 6 and 7 are views similar to FIGS. 4 and 5 and illustrating a still further form of tyre in accordance with the present invention;

FIG. 8 shows the components of the tire of FIGS. 6 and 7 separated from one another;

FIG. 9 is a view similar to that of FIG. 8 and showing further features;

FIG. 10 is a section illustrating a second embodiment of a tyre in accordance with the present invention;

FIG. 11 is a section through a further tyre in accordance with the second embodiment of the present invention;

FIG. 12 is a pictorial view of part of the tyre of FIG. 11; tread pattern into the crown.

### BRIEF DESCRIPTION OF THE INVENTION

According to one aspect of the present invention there is provided a pneumatic tyre which comprises first and second separable tyre parts, the first tyre part including the tyre's side walls and the inner layer of the tyre's crown and having reinforcing plies in it, and the second tyre part encircling the first tyre part and having the tread pattern therein.

In one form of the invention the said second tyre part has beads along both peripheries thereof, said beads being outwardly of said side walls of said first tyre part.

Said beads can be constituted by groups of cords or by one or more steel wires, and hold the second tyre part on the first tyre part. The first tyre part can have two circumferentially extending grooves in the side walls thereof for receiving the beads of the second part thereby properly to position the second tyre part.

The first tyre part can be in two separable sections each of which includes a tyre side wall and part of the crown. Said sections can abut along a circumferentially extending line in the centre plane of the tyre or can overlap.

Said parts can have an interlocking pattern of ribs and grooves to enhance the connection between the parts.

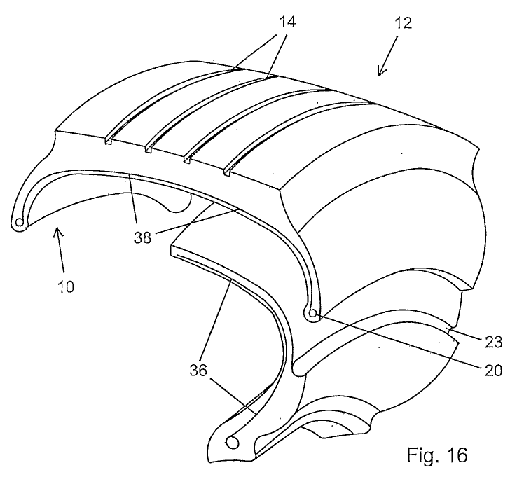

FIGS. 13 and 14 are views similar to FIGS. 11 and 12 and illustrating a still further form of tyre in accordance with the second embodiment of the present invention;

FIG. 15 shows the components of the tire of FIGS. 13 and 14 separated from one another; and

FIG. 16 is a view similar to that of FIG. 15 and showing further features.

### DETAILED DESCRIPTION OF THE DRAWINGS

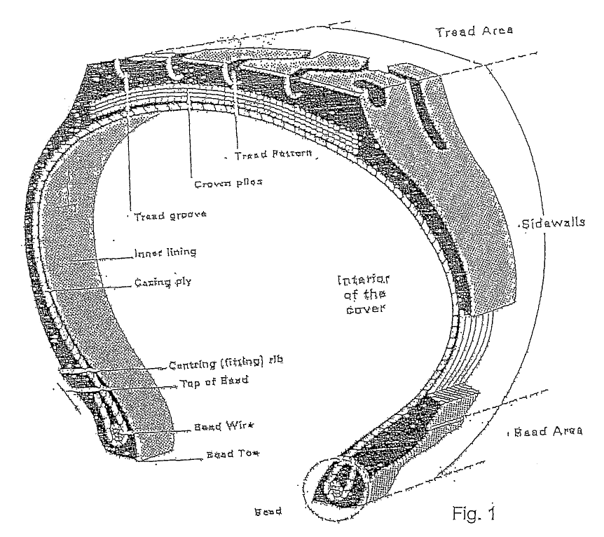

Referring firstly to FIG. 1, this illustrates a conventional tyre and identifies all the component parts thereof. The drawing is taken from the Wingfoot Training Centre's Basic Technical Tyre Programme manual.

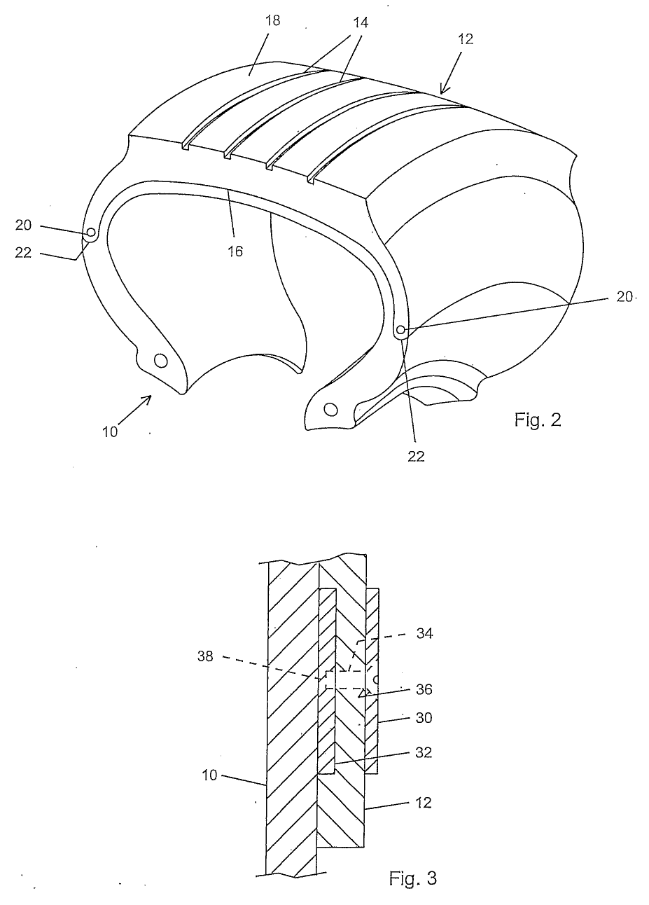

Referring now to FIG. 2, the tyre illustrated is a first embodiment of the invention and is constructed in two separable parts, namely, a radially inner part 10 and a radially outer part 12. The radially inner part 10 includes the inner lining, bead wires, casing plies and side walls all as illustrated in FIG. 1. The radially outer part 12 comprises the tread pattern which, in FIG. 2, is designated 14.

The radially outer part 12 has an inner face 16 and an outer face 18 in which the tread pattern 14 is formed.

Steel cords 20, or groups of steel cords, form circumferentially extending beads 22 along the edges of the outer part 12 and these grip the inner part 10.

Friction between the outer rubber surface of the part 10 and the inner rubber surface of the part 12, and the provision of the beads 22, ensures that, once inflation has taken place, there can be no slippage of the outer part 12 with respect to the inner part 10. Experimental work has shown that once the part 10 is inflated, the part 12 grips it so tightly that relative movement between them becomes impossible.

Similarly, the grip of the beads 22 on the inner part 10 prevents the outer part 12 separating from the inner part in a lateral movement.

An advantage of the construction shown is that, when the tyre is worn, the outer part 12 can be removed from the inner part 10, whilst the tyre is deflated, and replaced by an outer part 12 with a tread pattern of the requisite depth. It is possible to use as the inner part 10 a worn, but undamaged, conventional tyre which has been skimmed to remove the worn tread. Thus the worn tyre can be retreaded without using vulcanisation or any other form of adhesive for connecting the parts 10 and 12.

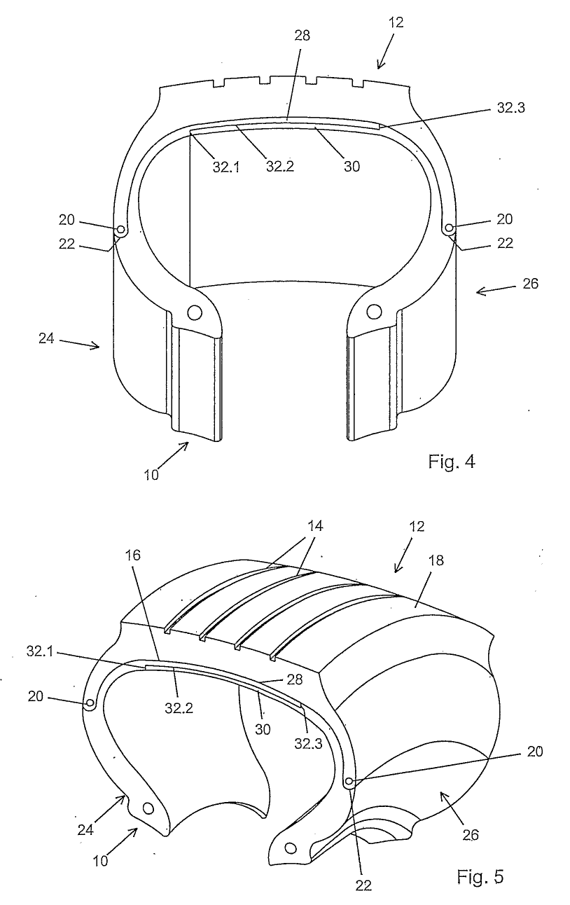

Referring now to FIG. 3, a portion of the inner part 10 and a portion of the outer part 12 are illustrated, the outer surface of the part 10 being smooth.

Two rings 30, 32 constitute the bead of the tyre of FIG. 3 and replace the cord 20 shown in FIG. 2.

Threaded fasteners 34 pass through the rings 30, 32 and through the outer tyre part 12. In the preferred form, the outer ring 30 has plain bores 36 therein and the inner ring has blind, tapped bores 38 therein. This ensures that the face of the inner ring 32 which is against the inner part 10 is smooth.

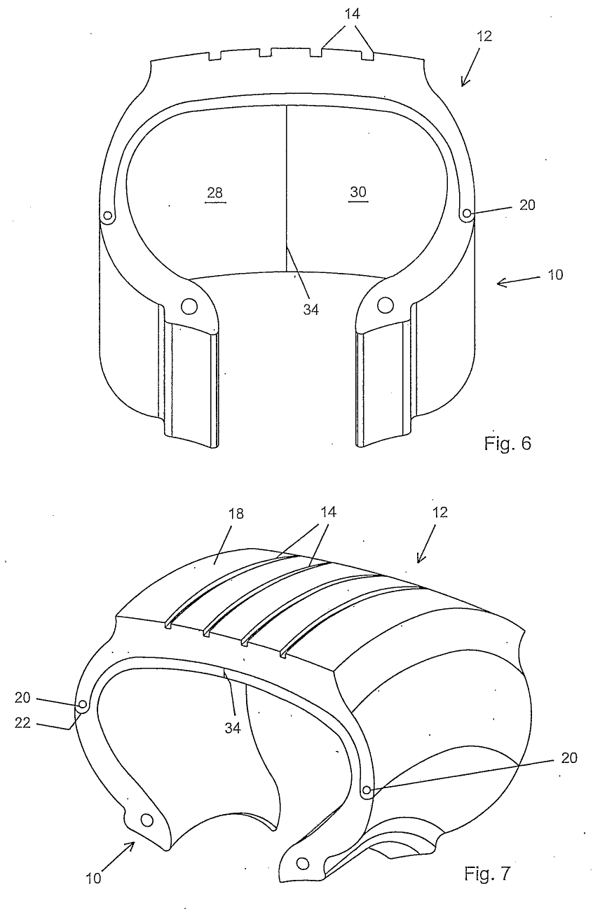

In FIGS. 4 and 5 the inner part is constructed in two sections 24, 26 each of which includes one side wall and has plies embedded in the portions designated 28 and 30 thereof. The portions 28 and 30 overlap to give the requisite number of plies in the tyre's crown. The spit line between the portions 28 and 30 is designated 32.1, 32.2 and 32.3.

Any tendency of the sections 24, 26 to separate on inflation is resisted by the outer part 12. Sealant can be applied to the part 32.1 of the split line to prevent air leakage.

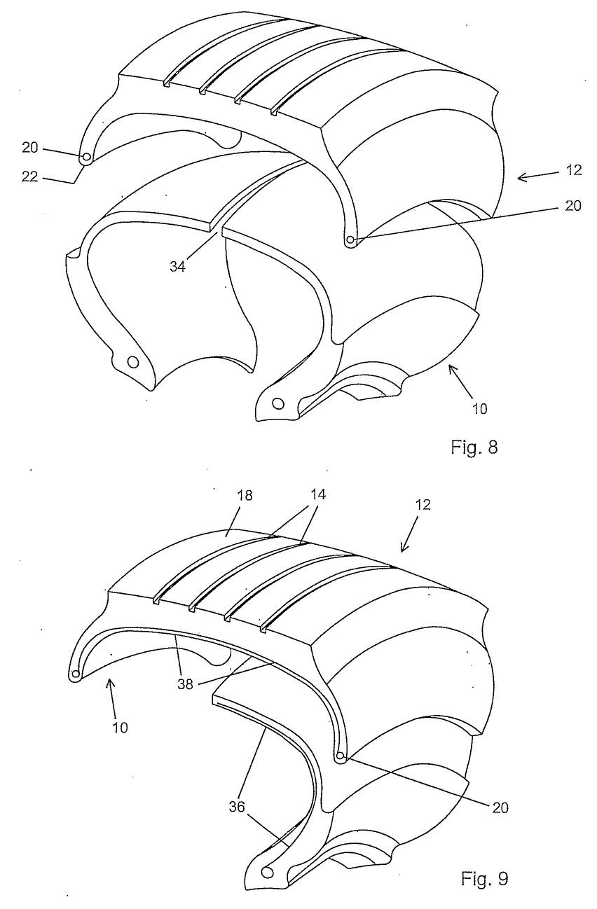

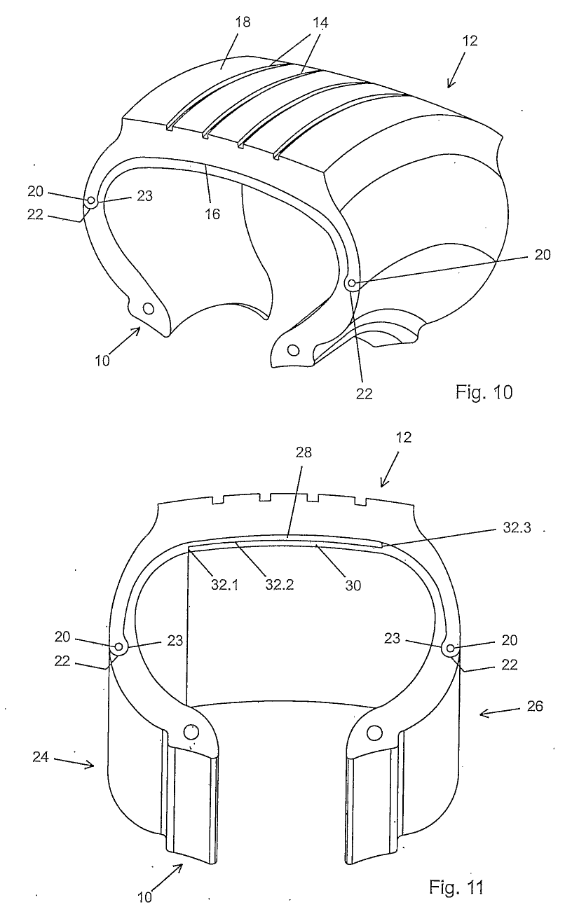

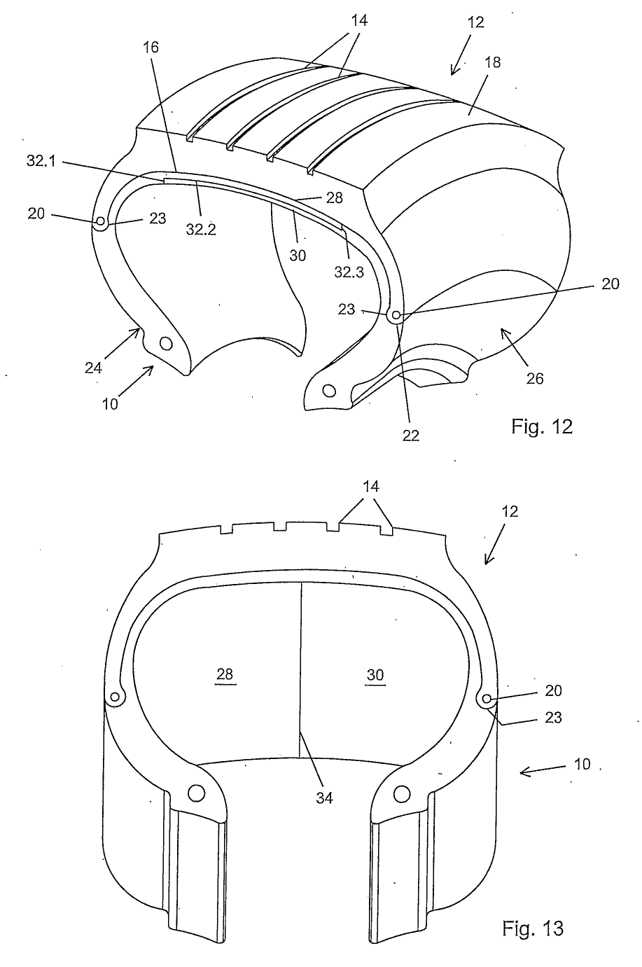

FIGS. 6 to 9 illustrate a tyre similar to that of FIGS. 4 and 5 except in that the portions 28 and 30 do not overlap but abut along the line 34. Each portion 28, 30 contains a sufficient number of plies to provide the requisite stiffness. The plies of the tyre are only shown in FIG. 9. The plies of the inner part 10 are designated 36 and the plies of the outer part 12 are designated 38.

Whilst the plies 38 are only shown in FIG. 9, it will be understood that such plies can be provided in the outer parts 12 of all the embodiments described and illustrated.

It is also possible to provide a pattern of ribs and grooves in the inner face 16 and the outer face of the inner part 10 so that there is a mechanical interlock between the inner and outer parts 10 and 12.

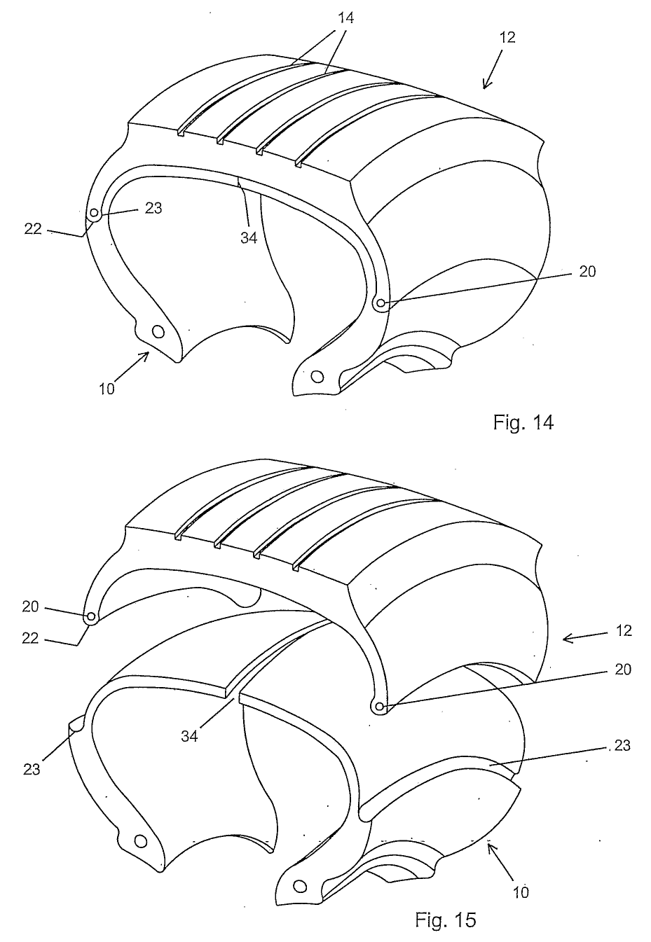

A second embodiment of a tyre in accordance with the invention is shown in FIGS. 10 to 16. Where applicable, like numbering to that used in FIGS. 2 to 9, has been used in FIGS. 10 to 16. In this embodiment, the inner part 10 has two circumferentially extending grooves 23 in which the beads 22 are located.

The present invention can be applied to tyres of the type known as steel belt radial tyres, to the type known as diagonal ply tyres and to the type known as cross ply tyres.

It is also possible to provide a pattern of ribs and grooves in the inner face 16 and the outer face of the inner part 10 so that there is a mechanical interlock between the inner and outer parts 10 and 12. Each manufacturer's tyre can have a different pattern or ribs and grooves thereby to make it impossible for an inner part 10 supplied by one manufacturer to be improperly retreaded using an outer part 12 supplied by another manufacturer.

1-10. (canceled)

11. A pneumatic tyre which comprises first and second tyre parts configured as separable tyre parts, said first tyre part including side walls and an inner layer of a crown and having reinforcing plies, and said second tyre part encircling said first tyre part and having a tread pattern therein, wherein said second tyre part has circumferential beads along both peripheries thereof, said beads configured outwardly of said side walls of said first tyre part.

12. The pneumatic tyre as claimed in claim 11 wherein said first tyre part defines two circumferentially extending grooves in which beads of said second tyre part are receivable.

13. The pneumatic tyre as claimed in claim 11 in which an outer face of said first tyre part and an inner face of said second tyre part are in abutment.

14. The pneumatic tyre as claimed in claim 13 wherein mechanical interlocking formations are provided on said first and said second tyre parts to lock said first and said second tyre parts together.

15. The pneumatic tyre as claimed in claim 14 wherein said interlocking formations are configured in an interlocking pattern of ribs and grooves.

16. The pneumatic tyre as claimed in claim 11 wherein said first tyre part is configured in two separable sections each of which includes a tyre side wall and part of said crown.

17. The pneumatic tyre as claimed in claim 16 wherein said sections abut along a circumferentially extending line in a centre plane of said tyre.

18. The pneumatic tyre as claimed in claim 16 wherein said sections overlap along a circumferentially extending line in said centre plane of said tyre.

19. The pneumatic tyre as claimed in claim 11 wherein at least one of said circumferential beads comprises two rings, which are attachable to said second tyre part with fasteners.

20. The pneumatic tyre as claimed in claim 11 wherein said first tyre part comprises part of a used conventional tyre.
